(19) United States
(12) Patent Application Publication
(10) Pub. No.: US 2024/0394764 A1
(43) Pub. Date: Nov. 28, 2024

(54) SIMULTANEOUS TRANSACTIONS ON SHARED DISPLAY DEVICES USING SCANNABLE CODES

(71) Applicant: Razorpay Inc., New Castle, DE (US)

(72) Inventors: Murali BRAHMADESAM, Karnataka (IN); Byas NAMBISAN, Karnataka (IN); Bhaskar CHATTERJEE, Karnataka (IN); Nikhil SINGH, Karnataka (IN)

(21) Appl. No.: 18/363,135

(22) Filed: Aug. 1, 2023

(30) Foreign Application Priority Data
May 24, 2023 (IN) 202311035982

(51) Int. Cl. G06Q 30/0601; G06K 7/14; G06Q 20/20; G06Q 20/32

(52) U.S. Cl. CPC G06Q 30/0601; G06K 7/1417; G06K 7/1447; G06Q 20/20; G06Q 20/322

(57) ABSTRACT

A scanning-based system to manage payments for multiple users comprises at least one processor that controls different components, where the components comprise order processing kiosks and display panels. The order processing kiosks are configured to receive multiple orders from the users and multiple order IDs are generated at each order processing kiosk, where a different order ID is assigned to each order that is placed by each user. The display panels are configured to receive an order created signal that is generated at the order processing kiosk, where each display panel displays multiple variable scannable codes. Each variable scannable code is designated with the previously assigned order ID and each user simultaneously scans a variable scannable code that is pertaining to their assigned order ID. Finally, the user performs the payment based on the assigned order ID and corresponding variable scannable code.

### TECHNICAL FIELD

The present invention relates to a modified mode of transaction, more specifically, a mode of transaction that involves multiple scannable codes that are displayed on a screen so that multiple users may perform the transaction simultaneously.

### BACKGROUND

Background description includes information that may be useful in understanding the present invention. It is not an admission that any of the information provided herein is prior art or relevant to the presently disclosed invention, or that any publication specifically or implicitly referenced is prior art.

In current methods adopted for transactions between a customer and a teller, the most common method is where the customer pays a certain amount to the teller via swiping a card in a POS (point of sale) device, or by making a direct cash transaction to the teller so that the customer is enabled to purchase a certain item or a service from the teller. The most modern methods involve the use of QR code-based systems, where the customer is enabled to scan a QR code (static QR code) that is displayed on a board or a frame. However, when there is a rush of multiple customers, they all cannot scan multiple QR codes at the same time. Going back to the single user payment system, after scanning of the QR code, the QR code directs the customer to the payment gateway and the user perform a payment of a certain amount of money from his/her account to the merchant/business' account.

However, even though the QR code-based method provides a solution to many issues in the previous methods, this method is still a high traffic business, for example, transactions in restaurants. The payment devices that are used in these business locations allow only a single customer at a time for payment using a static QR code. These businesses resort to using static QR codes to allow multiple customers to pay simultaneously. Use of static QR codes for payment puts the burden on the teller to reconcile the payment with the order, which is error prone.

Therefore, there is a need for a method or a system that shows multiple QR codes on a single screen that multiple customers can scan to pay simultaneously. This method or system is therefore intended to be used in high traffic outlets that may use multiple display devices to allow for higher scale. This relieves the burden of the tellers on manual reconciliation, as well as a better customer experience as upon payment the status of the payment and order status can be displayed on the same display device.

### SUMMARY OF THE INVENTION

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

A scanning-based system disclosed here addresses the above-mentioned need for a method or a system that shows multiple QR codes on a single screen so that multiple customers can scan to pay simultaneously. The scanning-based system to manage payments for multiple users comprises at least one processor that operates under control of a stored program comprising a sequence of program instructions to control one or more components, where the components comprise one or more order processing kiosks and one or more display panels. The order processing kiosks are configured to receive multiple orders from the users and multiple order IDs are generated at each order processing kiosk, where a different order ID is assigned to each order that is placed by each user. The display panels are configured to receive an order created signal that is generated at the order processing kiosk, where each display panel displays multiple variable scannable codes. Each variable scannable code is designated with the previously assigned order ID and each user simultaneously scans a variable scannable code that is pertaining to their assigned order ID. Finally, the user performs the payment based on the assigned order ID and corresponding variable scannable code.

In an embodiment, the placement of the order by the user is via a static scannable code that is scanned using a camera of a smart device, where the order is received at the order processing kiosk, and wherein the order processing kiosk generates the corresponding order IDs. In an embodiment, the static scannable code is a static quick response (QR) code that is displayed on one of a display frame or the display panel, and each variable scannable code is a dynamic QR code that is scanned by the user using the camera of the smart device. In an embodiment, a first and second user approaches proximal to the display panel that contains the variable scannable codes, wherein the first user scans a first variable scannable code associated with the first user's order ID, and simultaneously the second user scans a second variable scannable code that is associated with the second user's order ID, and wherein the processor in communication with the first and the second variable scannable codes processes each payment that is initiated from both the first and the second user and generates the payment status that indicates a successful or an unsuccessful transaction.

Disclosed herein is also a scanning-based method to manage payments for multiple users, the method comprising steps of: 1) providing at least one processor that operates under control of a stored program comprising a sequence of program instructions to control one or more components, wherein the components comprising one or more order processing kiosks and one or more display panels; 2) receiving multiple orders by one or more users at each order processing kiosk; 3) generating multiple order IDs by each order processing kiosk, wherein a different order ID is assigned to each order that is placed by each user; 4) transmitting an order created signal based on each order ID, via the order processing kiosk, to each display panel, wherein each display panel displays multiple variable scannable codes, and wherein each variable scannable code is designated with the previously assigned order ID; 5) scanning the variable scannable codes by the users simultaneously, wherein each user scans a variable scannable code that is pertaining to their assigned order ID; and 6) performing a payment by each user based on the assigned order ID and corresponding variable scannable code. In an embodiment, the processor that is in communication with the variable scannable code and the smart device of the user: a) retrieves information regarding successful completion of payment from the smart device of the user; b) shares the payment status to the order processing kiosk, wherein the order processing kiosk marks the payment status of the order based on the successful completion of the payment; and c) automatically sends a signal to the order processing kiosk for execution of the order based on the order ID.

In an example, after ringing up an order a cashier can push the payment to the dynamic QR code screen (display panel) and start ringing up the next order for the second customer while the first customer can make a payment on the QR screen. The QR screen can accommodate multiple QR codes with an order identifier and so the process of making payments can be done in parallel to ringing up orders on the billing system and this increases the throughput of the cashier by ensuring that multiple payments can be done simultaneously with order processing and payments, where the whole process is not a single threaded bottleneck in throughput.

These and other objects, embodiments and advantages of the present invention will become readily apparent to those skilled in the art from the following detailed description of the embodiments having reference to the attached figures, the invention not being limited to any particular embodiments disclosed.

### BRIEF DESCRIPTION OF FIGURES

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting its scope, for the subject matter may admit to other equally effective embodiments.

FIG. 1 exemplarily illustrates a schematic system diagram showing the working of the scanning-based system, as an example embodiment of the present disclosure.

FIG. 2 exemplarily illustrates a flow chart that illustrates the method performed by the scanning-based system, as an example embodiment of the present disclosure.

FIG. 3 exemplarily illustrates a display device that is used in the scanning-based system, as an example embodiment of the present disclosure.

FIG. 4 exemplarily illustrates a real-world example of the usefulness of the scanning-based system, as an example embodiment of the present disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

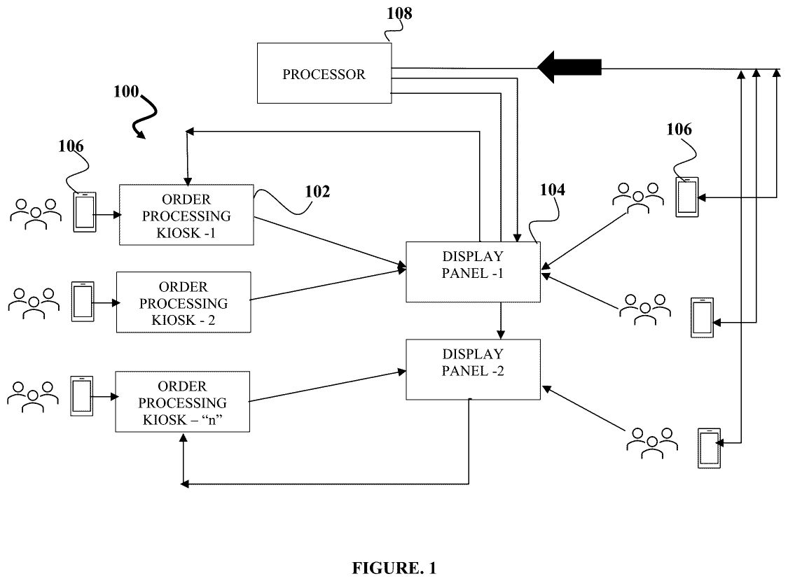

FIG. 1 exemplarily illustrates a schematic system diagram showing the working of the scanning-based system 100, as an example embodiment of the present disclosure. The scanning-based system 100 is designed to manage payments for multiple users. The fundamental solution that's intended from the scanning-based system 100 is to prevent long que's in market places, such as: restaurants where customers don't wish to wait for a long time to place orders, hospital billing counters where patients expect a faster payment process, movie theaters where the customers that arrive at the last minute still get a chance to book their tickets without too much manual assistance from the tellers, etc.

The scanning-based system 100 comprises at least one processor 108 that operates under control of a stored program comprising a sequence of program instructions to control one or more components, where the components comprise one or more order processing kiosks 102 and one or more display panels 104. As used herein, the term “processor” refers to a component of the scanning-based system 100 responsible for one or all of the following: maintaining record for the user accounts, comparing information from the variable scannable QR code and the customer's smart device 106 to determine payment status in a payment process, and to signal a kiosk 102 regarding execution of an order delivery based on successful payment status, or to pause an order delivery based on an unsuccessful payment status so that the user is prompted to initiate the payment again. The functions of the processor are not limited to the above-mentioned aspects.

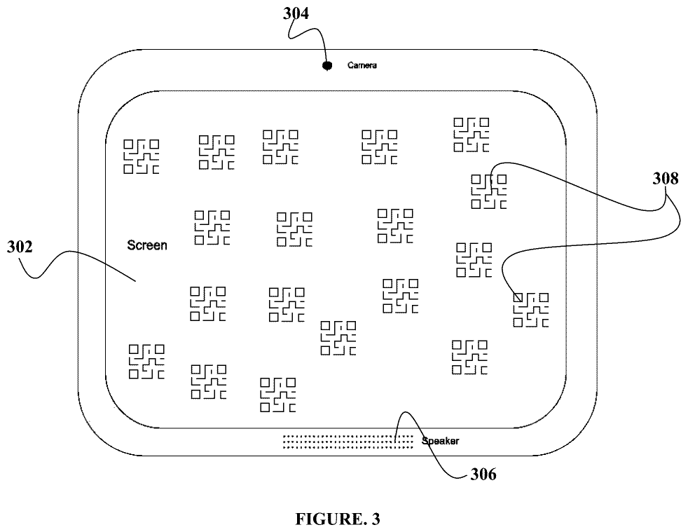

The order processing kiosks 102 are configured to receive multiple orders from the users and multiple order IDs are generated at each order processing kiosk 102, where a different order ID is assigned to each order that is placed by each user. As used herein, the term “kiosk” refers to a computer-controlled information display module that is normally accessible to the public for identifying/selecting information or in starting transactions. Generally, a kiosk section involves a display module for depicting product/service information to the customer and provides a keypad, keyboard, or touch screen along with a pointer device such as a mouse, so that the user can perform the choice of activity related to identifying or selecting information. Furthermore, the kind of kiosk arrangement in the present disclosure relates to multiple kiosk stations that multiple users may access simultaneously to identify or select information. The display panels 104 are configured to receive an order created signal that is generated at the order processing kiosk 102, where each display panel 104 displays multiple variable scannable codes 308 (as shown in FIG. 3). As used herein, the term “display panel” refers generally to large sized panels that are capable of displaying multiple codes to a large number of customers at the same time, which is further described in this disclosure. Each variable scannable code 308 is designated with the previously assigned order ID and each user simultaneously scans a variable scannable code 308 that is pertaining to their assigned order ID. Finally, the user performs the payment based on the assigned order ID and corresponding variable scannable code 308.

The users place the order using a static scannable code that is scanned using a camera of a smart device 106, where the order is received at the order processing kiosk 102, and the order processing kiosk 102 generates the corresponding order IDs. The static scannable code is a static quick response (QR) code that is displayed on one of a display frame or the display panel 104, and each variable scannable code 308 is a dynamic QR code that is scanned by the user using the camera of the smart device 106. The users place the order at the order processing kiosk 102 by selecting the items/services that are mentioned on the screens, for example, touch screens, that are available in the order processing kiosk 102. The user can also place an order by scanning a QR code and place the order at the order processing kiosk 102 by selecting the items/services that are mentioned on the screens, for example, touch screens, that are available in the order processing kiosk 102.

In an example, a first and second user approaches proximal to the display panel 104 that contains the variable scannable codes 308, where the first user scans a first variable scannable code 308 associated with the first user's order ID, and simultaneously the second user scans a second variable scannable code 308 that is associated with the second user's order ID, and wherein the processor 108 in communication with the first and the second variable scannable codes 308 processes each payment that is initiated from both the first and the second user and generates the payment status that indicates a successful or an unsuccessful transaction.

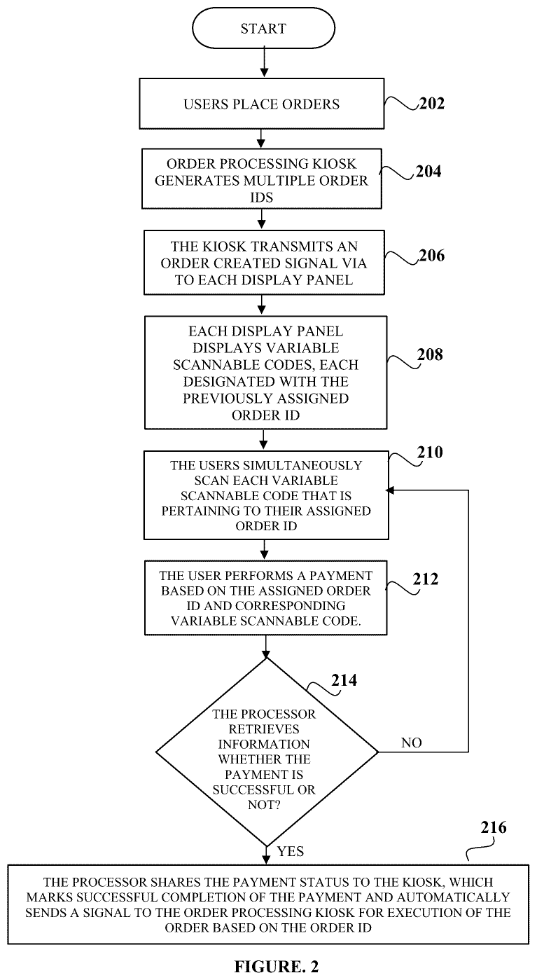

FIG. 2 exemplarily illustrates a flow chart that illustrates the method performed by the scanning-based system 100, as an example embodiment of the present disclosure.

Disclosed herein is also a scanning-based method to manage payments for multiple users, the method comprising steps of: 1) providing at least one processor 108 that operates under control of a stored program comprising a sequence of program instructions to control one or more components, wherein the components comprising one or more order processing kiosks 102 and one or more display panels 104; 2) the users place 202 orders, where each order processing kiosk 102 receives multiple orders; 3) generating 204 multiple order IDs by each order processing kiosk 102, wherein a different order ID is assigned to each order that is placed by each user; 4) transmitting 206 an order created signal based on each order ID, via the order processing kiosk 102, to each display panel 104, wherein each display panel 104 displays 208 multiple variable scannable codes 308, and wherein each variable scannable code 308 is designated with the previously assigned order ID; 5) scanning 210 the variable scannable codes 308 by the users simultaneously, wherein each user scans a variable scannable code 308 that is pertaining to their assigned order ID; and 6) performing 212 a payment by each user based on the assigned order ID and corresponding variable scannable code 308.

The processor 108 that is in communication with the variable scannable code 308 and the smart device 106 of the user: a) retrieves 214 information regarding successful completion of payment from the smart device 106 of the user, or in other words, retrieves information whether the payment is successful or not; b) shares 216 the payment status to the order processing kiosk 102, wherein the order processing kiosk 102 marks the payment status of the order based on the successful completion of the payment, and automatically 216 sends a signal to the order processing kiosk 102 for execution of the order based on the order ID. If the payment is unsuccessful, then the processor 108 prompts the user on his/her smart device 106 to scan the variable scannable code 308 that is pertaining to their assigned order ID.

In another example embodiment, the scanning-based system 100 is formed by representing “order processing kiosk 102” as a “point of sale (POS) device” and each “display panel 104” as a “Multi Dynamic QR device”. The steps involved in this embodiment comprises:

Step 1: The user places an order. The user chooses to make a payment by scanning the QR code.

Step 2: The POS device sends an order created signal to the Multi Dynamic QR device. The device shows the QR code associated with the user's order on the screen in addition to the other QR codes.

Step 3: The user walks to the device and scans the QR code associated with their order. Another user in the meantime (in parallel) scans another QR code associated with their order on the same device since it can display multiple QR codes at the same time.

Step 4: The user makes the payment via the portable device. The application on the portable device contacts a payment processor to fulfil the payment. The payment processor notified the application running on User's portable device when the payment succeeds.

Step 5: The payment processor also notifies the Multi Dynamic QR device about the payment made against a Dynamic QR code.

Step 6: The device then sends an update to the POS device letting it know about the payment status against a particular Order ID. This allows the POS system to store the status of a Payment against each Order ID eliminating the need to do manual reconciliation.

The scanning-based system 100 disclosed here allows businesses to use dynamic QR codes during peak hours as the point-of-sale devices can process only one customer at a time. The scanning-based system 100 is a cost-effective solution where a single display device can satisfy tens of customers at a single time, whereas to achieve a similar scale business would have to use multiple point of sale devices. Once payment is made, the scanning-based system 100 provides the status of the payment and order. The scanning-based system 100 intends to provide a better customer experience post the completion of the payment, for example, the customers can be presented with the option to track the order online by scanning a QR code.

FIG. 3 exemplarily illustrates a display panel 104 that is used in the scanning-based system 100, as an example embodiment of the present disclosure. The display panel 104 comprises a screen 302 for displaying the variable scannable codes 308, a camera 304 for identifying the customer, and a speaker 306 to prompt the customer if the payment status is complete or not.

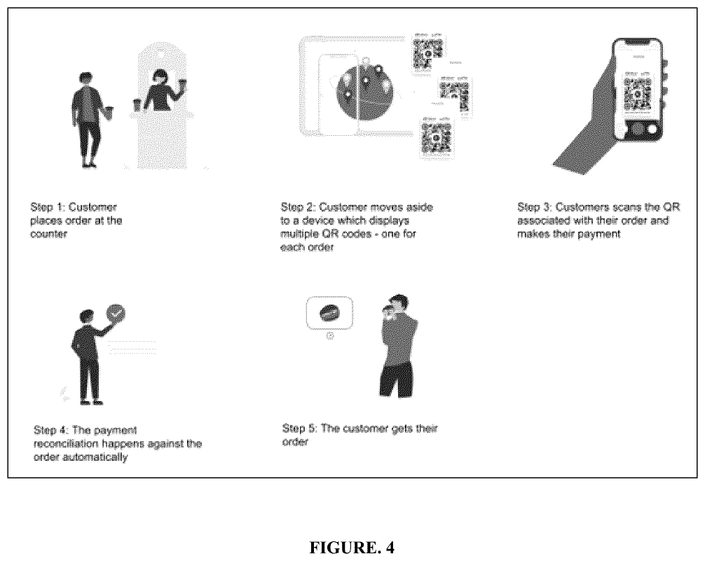

FIG. 4 exemplarily illustrates a real-world example of the usefulness of the scanning-based system 100, as an example embodiment of the present disclosure. A customer visits a famous takeaway burger joint with his/her friends. The customer waits in line for his/her turn. Once the turn of the customer is up, the teller takes his/her order and hands an order slip. The customer takes this order slip and heads to a device mounted at the side that displays multiple QR codes. Each QR code is a dynamic QR that is associated with a particular order. The customer simply scans the QR code against the corresponding order ID and makes the payment. Once the payment is done, the status of the payment gets synced with the order management system and the customer is served the order in some time. The display device shows multiple QR codes at the same time. So, while one customer is scanning a QR code against their order, another customer can scan the QR code associated with their order. The payment and order flows are kept separate on purpose so that the long queues are effectively managed. Dynamic QR codes help with automatic reconciliation which otherwise would have been a manual process for the teller.

As will be appreciated by one of skill in the art, the present invention may be embodied as a method, system, and apparatus. Accordingly, the present invention may take the form of an entirely hardware embodiment, a software embodiment or an embodiment combining software and hardware aspects.

It will be understood that each block of the block diagrams can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation of the scope of the invention.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

We claim:

1. A scanning-based system to manage payments for a plurality of users, the method comprising:
at least one processor that operates under control of a stored program comprising a sequence of program instructions to control one or more components, wherein the components comprising:
one or more order processing kiosks configured to receive a plurality of orders from the users, wherein a plurality of order IDs are generated at each order processing kiosk, wherein a different order ID is assigned to each order that is placed by each user; and
one or more display panels that are configured to receive an order created signal that is generated from the order processing kiosk based on each order ID, wherein each display panel displays a plurality of variable scannable codes, wherein each variable scannable code is designated with the previously assigned order ID, wherein each user simultaneously scans a variable scannable code that is pertaining to their assigned order ID, and performs the payment based on the assigned order ID and corresponding variable scannable code.

2. The scanning-based system as claimed in claim 1, wherein the placement of the order by the user is via a static scannable code that is scanned using a camera of a smart device, wherein the order is received at the order processing kiosk, and wherein the order processing kiosk generates the corresponding order IDs.

3. The scanning-based system as claimed in claim 2, wherein the static scannable code is a static quick response (QR) code that is displayed on one of a display frame or the display panel, and each variable scannable code is a dynamic QR code that is scanned by the user using the camera of the smart device.

4. The scanning-based system as claimed in claim 2, wherein the processor that is in communication with the variable scannable code and the smart device of the user:
retrieves information regarding successful completion of payment from the smart device of the user;
shares the payment status to the order processing kiosk, wherein the order processing kiosk marks the payment status of the order based on the successful completion of the payment; and
automatically sends a signal to the order processing kiosk for execution of the order based on the order ID.

5. The scanning-based system as claimed in claim 4, wherein a first and second user approaches proximal to the display panel that contains the variable scannable codes, wherein the first user scans a first variable scannable code associated with the first user's order ID, and simultaneously the second user scans a second variable scannable code that is associated with the second user's order ID, and wherein the processor in communication with the first and the second variable scannable codes processes each payment that is initiated from both the first and the second user and generates the payment status that indicates a successful or an unsuccessful transaction.

6. A scanning-based method to manage payments for a plurality of users, the method comprising:
providing at least one processor that operates under control of a stored program comprising a sequence of program instructions to control one or more components, wherein the components comprising one or more order processing kiosks and one or more display panels;
receiving a plurality of orders by one or more users at each order processing kiosk;
generating a plurality of order IDs by each order processing kiosk, wherein a different order ID is assigned to each order that is placed by each user;
transmitting an order created signal based on each order ID, via the order processing kiosk, to each display panel, wherein each display panel displays a plurality of variable scannable codes, and wherein each variable scannable code is designated with the previously assigned order ID;
scanning the variable scannable codes by a plurality of the users simultaneously, wherein each user scans a variable scannable code that is pertaining to their assigned order ID; and
performing a payment by each user based on the assigned order ID and corresponding variable scannable code.

7. The scanning-based method as claimed in claim 6, wherein the placement of the order by the user is via a static scannable code that is scanned using a camera of a smart device, wherein the order is received at the order processing kiosk, and wherein the order processing kiosk generates the corresponding order IDs.

8. The scanning-based method as claimed in claim 7, wherein the static scannable code is a static quick response (QR) code that is displayed on one of a display frame or the display panel, and each variable scannable code is a dynamic QR code that is scanned by the user using the camera of the smart device.

9. The scanning-based method as claimed in claim 6, wherein the processor that is in communication with the variable scannable code and the smart device of the user comprising steps of:
retrieving information regarding successful completion of payment from the smart device of the user;
sharing the payment status to the order processing kiosk, wherein the order processing kiosk marks the payment status of the order based on the successful completion of the payment; and
automatically sending a signal to the order processing kiosk for execution of the order based on the order ID.

10. The scanning-based method as claimed in claim 9, wherein a first and second user approaches proximal to the display panel that contains the variable scannable codes, wherein the first user scans a first variable scannable code associated with the first user's order ID, and simultaneously the second user scans a second variable scannable code that is associated with the second user's order ID, and wherein the processor in communication with the first and the second variable scannable codes processes each payment that is initiated from both the first and the second user and generates the payment status that indicates a successful or an unsuccessful transaction.

11. A computer programmed product having a computer-program recorded on storage computer-readable storage medium and at least one processor that operates under control of a stored program comprising a sequence of program instructions, to execute steps of:
receive a plurality of orders by one or more users at each order processing kiosk;
generate a plurality of order IDs by each order processing kiosk, wherein a different order ID is assigned to each order that is placed by each user;
transmit an order created signal based on each order ID, via the order processing kiosk, to each display panel, wherein each display panel displays a plurality of variable scannable codes, and wherein each variable scannable code is designated with the previously assigned order ID;
scan the variable scannable codes by a plurality of the users simultaneously, wherein each user scans a variable scannable code that is pertaining to their assigned order ID; and
perform a payment by each user based on the assigned order ID and corresponding variable scannable code.
